(19) United States
(12) Patent Application Publication
(10) Pub. No.: US 2009/0052723 A1
(43) Pub. Date: Feb. 26, 2009

(54) Speaker cabinet assembly for a speaker system

(75) Inventor: Steff Lin, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: HI-TECH SOUND SYSTEM CO., LTD., TAIPEI (TW)

(21) Appl. No.: 11/892,338

(22) Filed: Aug. 22, 2007

(51) Int. Cl. H04R 1/02

(52) U.S. Cl. 381/391

(57) ABSTRACT

A speaker cabinet assembly is disclosed to include a main cabinet, which is covered with a face panel and a grille in the face panel for carrying a tweeter and a woofer and having a through hole at one side and a tubular flange protruded from the outside wall around the through hole, a sub cabinet, which has a through hole at one side and a tubular flange protruded from the outside wall around the through hole, and a flexible tubular connector is connected between the tubular flange of the main cabinet and the tubular flange of the sub cabinet to guide sound waves from the main cabinet into the sub cabinet.

### BACKGROUND OF THE INVENTION

1. Field of the Invention

The present invention relates to a speaker cabinet and more particularly, to a speaker cabinet assembly, which uses a sub cabinet to enhance the output sound quality of the speaker system and, is convenient for installation in a partition wall.

2. Description of the Related Art

A conventional speaker cabinet assembly for installation in a partition wall, as shown in FIG. 1, comprises a cabinet 1, which holds a tweeter 11, a woofer 12, and other speaker elements, an inner frame 13 covered on the cabinet 1, an outer frame 14 fastened to the inner frame 13, and a grille 15 mounted in the outer frame 14. During installation of the speaker cabinet assembly in a partition wall 2, the partition wall 2 is cut to provide a hole 21 subject to the size of the cabinet 1, and then the cabinet 1 is inserted into the hole 21 to keep the outer frame 14 stopped against the outer surface of the partition wall 2. Because the enclosed space of the cabinet 1 is limited, the performance of the speaker cabinet assembly is also limited. Increasing the size of the cabinet 1 can relatively improve the sound quality of the speaker system. However, under space limitation, the size of the cabinet 1 is limited.

### SUMMARY OF THE INVENTION

The present invention has been accomplished under the circumstances in view. It is therefore the main object of the present invention to provide a speaker cabinet assembly, which enhances the output sound quality of the speaker system and, is convenient for installation in a partition wall.

According to one aspect of the present invention, the speaker cabinet assembly comprises a main cabinet, a sub cabinet, and a flexible tubular connector. The main cabinet is covered with a face panel and a grille in the face panel for carrying a tweeter and a woofer, having a through hole at one side and a tubular flange protruded from the outside wall around the through hole. The sub cabinet has a through hole at one side and a tubular flange protruded from the outside wall around the through hole. The flexible tubular connector is connected between the tubular flange of the main cabinet and the tubular flange of the sub cabinet to guide sound waves from the main cabinet into the sub cabinet.

According to another aspect of the present invention, the flexible tubular connector is made out of rubber.

According to still another aspect of the present invention, the flexible tubular connector is preferably made in the form of a flexible bellows tube.

### BRIEF DESCRIPTION OF THE DRAWINGS

FIG. 1 is a sectional view of a speaker cabinet according to the prior art.

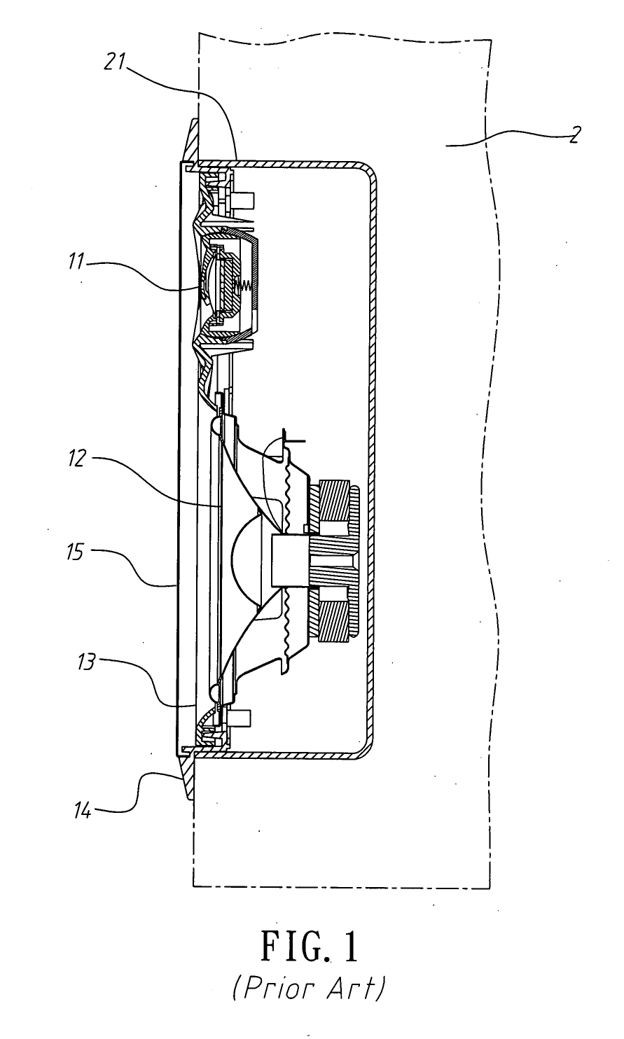

FIG. 2 is an exploded view of the preferred embodiment of the present invention.

FIG. 3 is a sectional view of the preferred embodiment of the present invention.

FIG. 4 is a schematic view of the preferred embodiment of the present invention, showing the speaker cabinet assembly in function.

### DETAILED DESCRIPTION OF THE PREFERRED EMBODIMENT

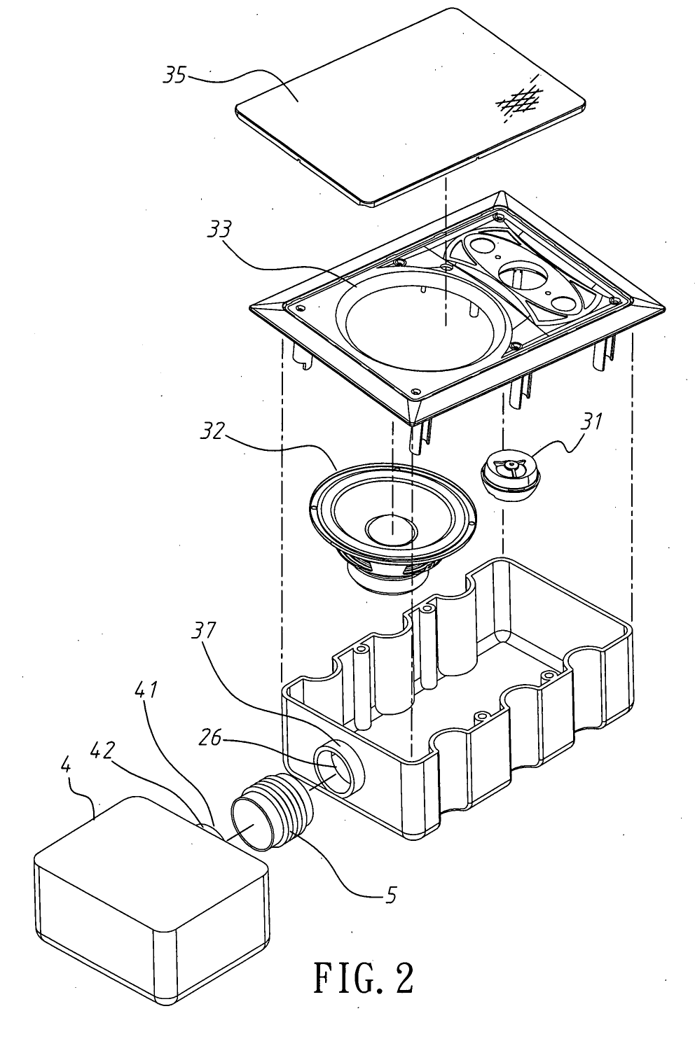

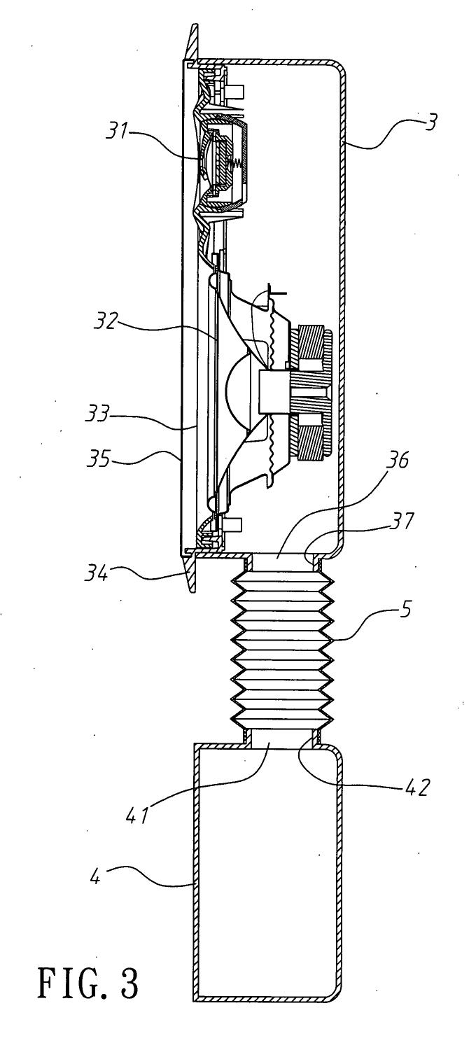

Referring to FIGS. 2 and 3, a speaker cabinet assembly in accordance with the present invention is shown comprising a main cabinet 3, a sub cabinet 4, and a tubular connector 5.

The main cabinet 3 carries a tweeter 31, a woofer 32, and other speaker elements. The main cabinet 3 is covered with a face panel 33, which carries a grille 35. The main cabinet 3 has a through hole 36 at one side, and a tubular flange 37 protruded from the outside wall around the through hole 36.

The sub cabinet 4 has a through hole 41 at one side, and a flange 42 protruded from the outside wall around the through hole 41.

The tubular connector 5 is made out of rubber or other elastic material in the shape of a bellows tube for the advantage of being elastically deformable.

The tubular connector 5 has one end fastened to the tubular flange 37 of the main cabinet 3, and the other end fastened to the tubular flange 42 of the sub cabinet 4. Thus, the tubular connector 5 guide sound waves from the main cabinet 3 into the sub cabinet 4 to enhance the sound and to improve the sound quality. During installation of the speaker cabinet assembly in a partition wall, the elastically deformable property of the tubular connector 5 allows the sub cabinet 4 to be kept in a hole inside the partition wall as the main cabinet 3 is attached to the outer surface of the partition wall.

Referring to FIG. 3, during installation of the speaker cabinet assembly in a partition wall 2, the partition wall 2 is properly cut to provide a hole 21, and then the sub cabinet 4 is put in the hole 21, and then the face panel 33 of the main cabinet 3 is fastened to the peripheral edge of the hole 21. Because the tubular connector 5 is elastically deformable, the installation of the speaker cabinet assembly in the hole 21 of the partition wall 2 is easy.

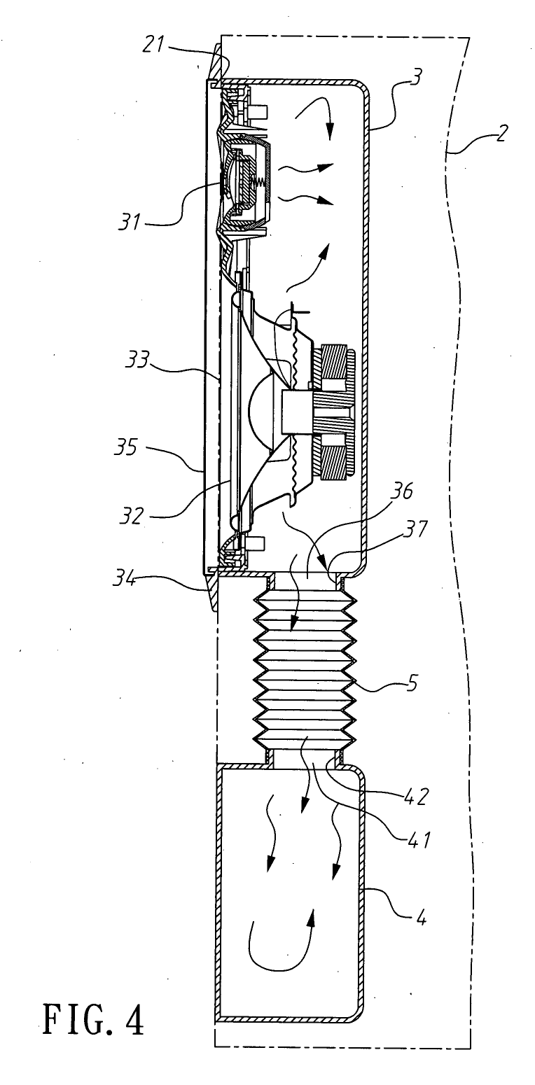

Referring to FIG. 4, the face panel 33 of the main cabinet 3 is fastened to the peripheral edge of the hole 21 of the partition wall 2, and the sub cabinet 4 is kept at the bottom side of the main cabinet 3. During the operation of the speaker system, sounds produced by the tweeter 31 and the woofer 32 are oscillating in the main cabinet 3 and the sub cabinet 4, enhancing the output quality of the speaker system.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A speaker cabinet assembly, comprising:
a main cabinet covered with a face panel and a grille in said face panel for carrying a tweeter and a woofer, said main cabinet having a through hole at one side thereof and a tubular flange protruded from an outside wall thereof around the through hole of said main cabinet;
a sub cabinet, said sub cabinet having a through hole at one side thereof and a tubular flange protruded from an outside wall thereof around the through hole of said sub cabinet; and
a flexible tubular connector connected between the tubular flange of said main cabinet and the tubular flange of said sub cabinet to guide sound waves from said main cabinet into said sub cabinet.

2. The speaker cabinet assembly as claimed in claim 1, wherein said flexible tubular connector is made out of rubber.

3. The speaker cabinet assembly as claimed in claim 1, wherein said flexible tubular connector is a flexible bellows tube.
